(19) United States
(12) Patent Application Publication
(10) Pub. No.: US 2022/0219323 A1
(43) Pub. Date: Jul. 14, 2022

(54) METHOD AND SYSTEM FOR OPERATING A ROBOT

(71) Applicant: KUKA Deutschland GmbH, Augsburg (DE)

(72) Inventor: Markus Wuensch, Augsburg (DE)

(21) Appl. No.: 17/606,293

(22) PCT Filed: Mar. 26, 2020
(86) PCT No.: PCT/EP2020/058450

§ 371 Date: Dec. 6, 2021

(30) Foreign Application Priority Data
Apr. 26, 2019 (DE) 10 2019 206 012.9

(51) Int. Cl. B25J 9/16; B25J 19/02; G06V 20/52

(52) U.S. Cl. CPC B25J 9/1676; B25J 9/1666; G06V 20/52; B25J 9/162; B25J 19/022; B25J 9/1651

(57) ABSTRACT

A method for operating at least one robot includes determining the minimum distance of the robot from an obstacle, in particular the closest obstacle to the robot, in particular excluding at least one previously known, in particular temporary, obstacle; reducing the maximum speed of the robot if this minimum distance is below a first minimum distance; and reducing this maximum speed of the robot more if the minimum distance is below a second minimum distance which is smaller than the first minimum distance.

### CROSS-REFERENCE TO RELATED APPLICATIONS

This application is a national phase application under 35 U.S.C. § 371 of International Patent Application No. PCT/EP2020/058450, filed Mar. 26, 2020 (pending), which claims the benefit of priority to German Patent Application No. DE 10 2019 206 012.9, filed Apr. 26, 2019, the disclosures of which are incorporated by reference herein in their entirety.

### TECHNICAL FIELD

The present invention relates to a method and to a system for operating at least one robot, and to a computer program product for carrying out the method.

### BACKGROUND

It is known from in-house practice to monitor protection areas of robots and to shut down the robot if an object unexpectedly enters the monitored protection area.

### SUMMARY

The object of the present invention is to improve the operation of robots.

This object is achieved by a method and a system or computer program product for carrying out a method as described herein.

According to one embodiment of the present invention, a method for operating one or more robots has the following steps:

determining a minimum distance of (each of) the robot(s) from an, in particular unforeseen, obstacle;

reducing a maximum velocity of the given robot(s) if this minimum distance falls below a first minimum distance; and

reducing this maximum velocity of the given robot(s) even more if the minimum distance falls below a second minimum distance which is less than the first minimum distance.

As a result, in one embodiment, in particular in contrast to a mere shutdown when a protection area is breached, operation of the robot or robots can be improved; in particular, a higher process velocity can be achieved and/or human-robot cooperation can be improved by dynamically reducing the maximum velocity.

In one embodiment, the minimum distance is determined as the minimum distance from the specific obstacle—among a plurality of, in particular unforeseen, obstacles—whose (minimum) distance from the given robot(s) is the least (“the obstacle closest to the robot”). In one embodiment, the minimum distances to a plurality of obstacles are determined for this purpose, and from this determination, the least of these distances (the minimum distances in each case for this obstacle) is selected as the minimum distance between the robot and the obstacle (closest to the robot).

This is based on the idea that in each case the obstacle closest to the robot has the greatest probability of collision, which can thus be reduced particularly advantageously in one embodiment.

Additionally or alternatively, in one embodiment, one or more previously known, in particular temporary obstacles (obstacles temporarily present in the detection area) are excluded or hidden during and/or for the determination of the minimum distance. For example, a further mobile robot, an autonomous transport vehicle, or the like, can register itself and then be excluded as a previously known, temporary obstacle when determining the minimum distance.

In this way, unforeseen obstacles, in particular people, can advantageously be protected in an embodiment.

In one embodiment, the method has the step of:

reducing the maximum velocity of the given robot(s) even more if the minimum distance falls below a third minimum distance that is less than the second minimum distance,

and in a further development of this embodiment, has the further step of:

reducing the maximum velocity of the given robot(s) even more if the minimum distance falls below a prespecified fourth minimum distance, which is less than the third minimum distance.

As a result, in one embodiment, operation of the robot(s) can be further improved—in particular, through a differentiated and/or further-differentiated reduction in the maximum velocity, an (even) higher process velocity can be achieved, and/or human-robot cooperation can be (further) improved.

In one embodiment, the maximum velocity is reduced to zero or the given robot(s) is stopped when values fall below the second, third or, in particular, fourth limit value.

Additionally or alternatively, the maximum velocity is reduced in one embodiment when values fall below the second, in particular third, or fourth limit value, to a human-robot cooperation velocity that is specified for human-robot cooperation—in one embodiment, (only) if the robot is configured to stop when it comes into contact with an obstacle.

In one embodiment, the first, second, third and/or fourth minimum distance is greater than zero. In other words, in one embodiment, the maximum velocity is already reduced (successively) when the obstacle and the robot approach each other, or before contact between the obstacle and the robot.

As a result, in one embodiment, collisions between robots and people can be avoided or their consequences can be reduced and/or a higher process speed can be achieved and/or human-robot cooperation can be (further) improved.

The or one or more of the robots (each) has/have in one embodiment a stationary or environmentally stable or mobile, in particular mobile, base, and/or at least one robot arm—in particular arranged thereon—with at least three, in particular at least six, and in one embodiment at least seven, joints and joint actuators or drives.

In particular because of its complexity or variability, the present invention can be used with particular advantage in such robots.

In one embodiment, the minimum distance is a Cartesian distance; in one embodiment, it is a length of a spatial or three-dimensional connecting line or a two-dimensional projection thereof, in particular onto a horizontal plane.

In one embodiment, the maximum velocity is a permissible or (maximum) permissible prespecified speed or a velocity limit of the given robot(s), in particular of a robot-based reference; in one embodiment, this reference is an end effector of the robot arm, a mobile base, or the like.

In one embodiment, a pose of the obstacle is determined; in one embodiment, it is determined relative to an environment-based reference, in particular (in) an environment-based reference system. In one embodiment, a pose of the obstacle comprises a one-, two- or three-dimensional position and/or a one-, two- or three-dimensional orientation of the obstacle.

Additionally or alternatively, a pose of the given robot(s) is determined in one embodiment; in one embodiment, it is determined relative to an environment-based reference, in particular (in) an environment-based reference system; in one embodiment, it is determined relative to the same reference or the same reference system as the pose of the obstacle. In one embodiment, a pose of the robot includes a (joint) position of the robot and/or a one-, two- or three-dimensional position and/or a one-, two- or three-dimensional orientation of one or more robot-based references, in particular links, in particular an elbow, an end effector, and/or a payload of the robot.

In one embodiment, the minimum distance is determined (in each case) on the basis of this pose of the obstacle and/or on the basis of this pose of the robot. By determining the distance in a common reference system, in one embodiment the distance can be determined particularly advantageously, in particular (more) simply and/or (more) reliably.

If, in one embodiment, the determined pose of the robot includes the position and/or orientation of a plurality of robot-based references, in particular links or link points, of the robot, in one embodiment the least of the minimum distances between these robot-based references is determined as the minimum distance between these robot-based references and the obstacle. In one embodiment, for this purpose, the minimum distances between the obstacle and the various robot-based references are first determined and, among these, the least is selected as the minimum distance between the robot and the obstacle.

This is based on the idea that the robot-based reference closest to the obstacle has the greatest collision probability, which can consequently be reduced.

As such, in one embodiment, the minimum distances between the obstacle and the reference are determined for a plurality of obstacles and a plurality of robot-based references, and from this, the least distance is selected or determined as the minimum distance between the robot and an obstacle closest to the robot.

In a further development, the pose, in particular the position(s) and/or orientation(s) of one or more robot-based references, in particular links, of the robot is determined on the basis of a detected joint position of the robot; in one embodiment, it is determined by means of a forward transformation based on a kinematic model of the robot.

Additionally or alternatively, the pose of the robot in a further development is based on an—in particular, detected or actual or prespecified or planned—end effector and/or a—in particular, detected or actual or prespecified or planned—payload carried by the robot, in particular a prespecified dimension of the end effector or the payload.

In this way, in one embodiment, the distance can be determined particularly advantageously in each case, in particular in combination, in particular (more) simply and/or (more) reliably.

In one embodiment, the minimum distance, in particular the pose of the obstacle and/or the robot, is determined with the aid of one or more sensors; in one embodiment, it is determined with the aid of one or more sensors in the environment and/or one or more robot-based sensors, in particular with the aid of image processing, laser light, ultrasound, radar emission, a light grid, a projection and/or in a capacitive manner.

In one embodiment, the determination in a, in particular common, reference system can be improved by means of environmental sensors, the detection of obstacles can be improved in particular by image processing, the precision can be improved in particular by laser light, and safety can be improved in particular by a light grid and a projection. In one version, ultrasound and radar emission can reduce disruption in the operation of the robot.

In one embodiment, the minimum distance is determined with the aid of, in particular in or by, at least one data processing device which is external to the robot, in particular in a central data processing device for two or more robots—in one embodiment, in a (security) cloud. As a result, in one embodiment, the invention can advantageously be used for a plurality of robots at the same time, and/or simply adapted to and/or used for individual robots.

Likewise, in one embodiment, the minimum distance can also be determined in a robot controller and, as a result, its modules can advantageously be used, for example for forward transformation or the like.

In one embodiment, a minimum distance from a spatial area among a group which comprises a plurality of, in one embodiment, environment-based, prespecified, discrete, in particular two- or three-dimensional, spatial areas is determined as the minimum distance. In a further development, the minimum distance is determined as a minimum distance between a first spatial area among a group which comprises a plurality of prespecified, discrete, in particular two- or three-dimensional, spatial areas, in particular fixed in the environment, and a second spatial area among this or another group, which comprises a plurality of prespecified, discrete, in particular two- or three-dimensional, spatial areas, in particular fixed in the environment. For a more concise explanation, two-dimensional areas, in particular floor areas, are generally referred to as (two-dimensional) spatial areas. In one embodiment, a spatial area extends over the entire height of a detection or monitoring area.

As such, in particular, in one embodiment, one, in particular two- or three-dimensional, monitoring area for obstacles and/or one, in particular two- or three-dimensional, monitoring area for the robot is (in each case) discretized into a plurality of prespecified spatial areas, and then each minimum distance to the spatial area (closest to the robot) that is (still) penetrated by the given obstacle, or in which the given obstacle is at least partially present, and/or to the spatial area (closest to the obstacle) that is (still) penetrated or in which the robot is at least partially present is determined as the minimum distance in each case.

In this way, in one embodiment, the distance can be determined particularly advantageously in each case, in particular in combination, in particular (more) simply and/or (more) reliably.

In one embodiment, the maximum velocity is reduced in steps between at least two minimum distances, in particular between the first and second minimum distances, between the second and third minimum distances, and/or between the third and fourth minimum distances.

Additionally or alternatively, in one embodiment, the maximum velocity is continuously reduced between at least two minimum distances, in particular between the first and second minimum distances, between the second and third minimum distances, and/or between the third and fourth minimum distances.

By means of an at least partially step-like reduction, a (more) simple and/or (more) reliable monitoring can advantageously be implemented and/or carried out; by means of an at least partially continuous reduction, in particular a (more) differentiated and/or more sensitive monitoring can be carried out.

In one embodiment, the maximum velocity is reduced on the basis of a relative velocity between the obstacle and the robot. In a further development, the maximum velocity is reduced if (it is detected that) the minimum distance is equal to the second minimum distance and the obstacle and robot are moving away from each other, and it is reduced even more relative thereto if (it is detected that) the minimum distance is equal to the second minimum distance and the obstacle and robot are moving towards each other.

Additionally or alternatively, the maximum velocity is reduced in one embodiment on the basis of a planned movement of the robot. In a further development, the maximum velocity is reduced if (it is detected that) the minimum distance is equal to the second minimum distance and, based on the planned robot path, it is predicted that this minimum distance will (again) increase, and it is reduced even more relative thereto if (it is detected that) the minimum distance is equal to the second minimum distance and, based on the planned robot path, it is predicted that this minimum distance will (even further) decrease.

As a result, in one embodiment, the maximum velocity can be adjusted predictively, in particular in combination.

Additionally or alternatively, the maximum velocity is reduced in one embodiment as a function of a robot outreach. In a further development, the maximum velocity is reduced if (it is detected that) the minimum distance is equal to the second minimum distance and the robot has a first working reach, and it is reduced even more relative thereto if (it is detected that) the minimum distance is equal to the second minimum distance and the robot has a greater second working reach.

Additionally or alternatively, the maximum velocity is reduced in one embodiment as a function of a payload carried by the robot. In a further development, the maximum velocity is reduced if (it is detected that) the minimum distance is equal to the second minimum distance and the robot is carrying a first payload, and it is reduced even more relative thereto if (it is detected that) the minimum distance is equal to the second minimum distance and the robot is carrying a greater, second payload.

Additionally or alternatively, the maximum velocity is reduced in one embodiment as a function of the current velocity of the robot. In a further development, the maximum velocity is reduced by a first amount if (it is detected that) the minimum distance is equal to the second minimum distance and the robot has a first current velocity, and is reduced by a greater, second amount if (it is detected that) the minimum distance is equal to the second minimum distance and the robot has a greater, second current velocity.

In this way, in one embodiment, in particular in combination, the consequences of a collision can advantageously be reduced.

In one embodiment, the reduction of the maximum velocity is parameterized by a user, in particular directly or indirectly, for example by means of a table, function or the like, the first, second, third and/or fourth minimum distance and/or the, in particular associated, reduction of the maximum velocity, especially its amount.

Additionally or alternatively, in one embodiment, the reduction of the maximum velocity is parameterized on the basis of a configuration of a signal transmission, on the basis of a configuration of the robot, and/or on the basis of a configuration of a sensor for determining the minimum distance. In a further development, the reduction of the maximum velocity is parameterized in such a way that the maximum velocity is reduced for a minimum distance equal to the second minimum distance if the signal transmission, the robot, and/or the sensor (each) have a first configuration, and for a minimum distance equal to the second minimum distance, is reduced even more if the signal transmission, the robot or the sensor has a different second configuration, in particular if the signal transmission has longer communication times, the sensor has longer response times, or a coarser detection is available, or the like.

According to one embodiment of the present invention, a system, in particular in terms of hardware and/or software, in particular in terms of programming, is configured to carry out a method described herein and/or comprises:

means for determining a minimum distance between the robot and an obstacle, in particular closest to the robot, in particular while excluding at least one previously known, in particular temporary, obstacle;

means for reducing a maximum velocity of the robot if this minimum distance falls below a first minimum distance; and

means for reducing this maximum velocity of the robot even more if the minimum distance falls below a second minimum distance which is less than the first minimum distance.

In one embodiment, the system or its means comprises:

means for determining a pose of the obstacle, in particular relative to an environment-based reference; and/or

means for determining a pose of the robot, in particular relative to an—in particular, the same—environment-based reference and/or on the basis of an end effector and/or a detected joint position of the robot and/or a payload carried by the robot; and/or

means for determining the minimum distance on the basis of this pose of the obstacle and/or the robot;

at least one, in particular environment-based or robot-based, sensor for determining the minimum distance, in particular the pose of the obstacle and/or of the robot, in particular means for determining the minimum distance by means of image processing, laser light, ultrasound, radar emission, a light grid, a projection and/or in a capacitive manner; and/or

at least one data processing device external to the robot for determining the minimum distance; and/or

means for determining a minimum distance to a spatial area among a group comprising a plurality of, prespecified, discrete spatial areas, in particular, fixed in the environment, in particular between a first spatial area of a group which comprises a plurality of, prespecified, discrete spatial areas fixed in the environment, and a second spatial area of this or a further group which comprises a plurality of prespecified, discrete spatial areas, as a minimum distance; and/or

means for gradually or continuously reducing the maximum velocity between at least two minimum distances; and/or

means for reducing the maximum velocity on the basis of a relative velocity between the obstacle and the robot and/or on the basis of a planned movement of the robot and/or as a function of a working reach, current velocity and/or payload; and/or

means for parameterizing the reduction of the maximum velocity by a user and/or on the basis of a configuration of a signal transmission, of the robot, and/or of a sensor for determining the minimum distance.

A means within the meaning of the present invention may be designed in hardware and/or in software, and in particular may comprise a data-connected or signal-connected, in particular, digital, processing unit, in particular microprocessor unit (CPU), graphic card (GPU) having a memory and/or bus system or the like and/or one or multiple programs or program modules. The processing unit may be designed to process commands that are implemented as a program stored in a memory system, to detect input signals from a data bus and/or to output output signals to a data bus. A storage system may comprise one or a plurality of, in particular different, storage media, in particular optical, magnetic, solid-state and/or other non-volatile media. The program may be designed in such a way that it embodies or is capable of carrying out the methods described herein, so that the processing unit is able to carry out the steps of such methods and thus, in particular, is able to operate the robot. In one embodiment, a computer program product may comprise, in particular, a non-volatile storage medium for storing a program or comprise a program stored thereon, an execution of this program prompting a system or a controller, in particular a computer, to carry out the method described herein or one or multiple of steps thereof.

In one embodiment, one or multiple, in particular all, steps of the method are carried out completely or partially automatically, in particular by the system or its means.

In one embodiment, the system includes the robot(s).

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically depicts two robots and a system for operating the robots according to an embodiment of the present invention;

FIG. 2 illustrates a method of operating the robots according to an embodiment of the present invention; and

FIG. 3 illustrates a reduction in a maximum velocity according to an embodiment of the present invention.

### DETAILED DESCRIPTION

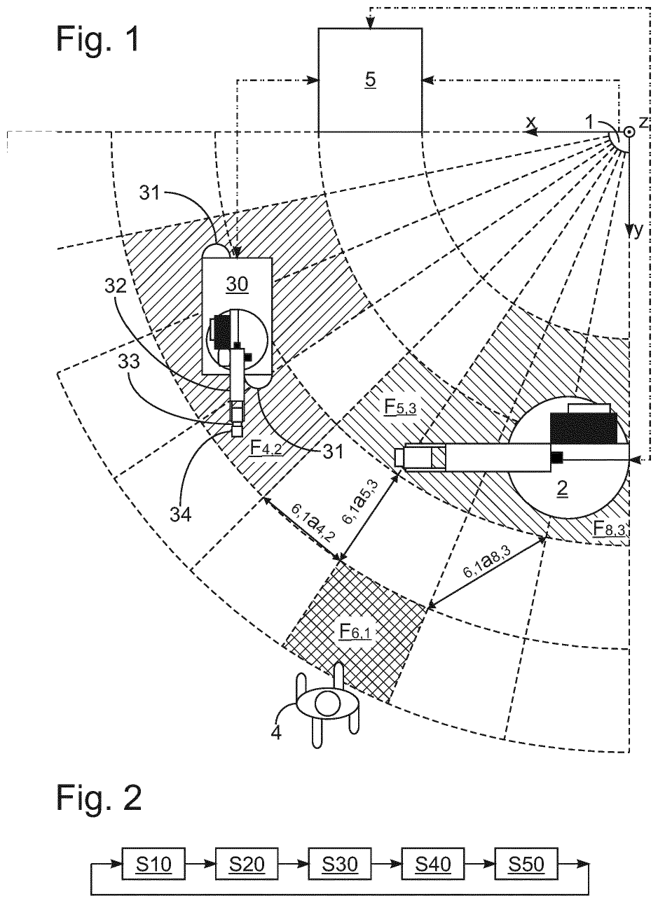

FIG. 1 shows an example of a stationary robot 2 and a mobile robot 30 with a robot arm 32 with an end effector in the form of a gripper 33 with a payload 34, and a system for operating these robots according to an embodiment of the present invention.

The system has a sensor 1 fixed in the environment, for example a camera with image processing, and sensors 31 fixed to the robot 30, for example laser scanners.

A common monitoring space of the sensors 1, 31 is divided into prespecified spatial areas that are fixed in the environment, as indicated by dashed lines in FIG. 1.

A data processing device 5 which is external to the robot receives joint positions of the robots 2, 30, and also signals from the sensors 1, 31.

From the joint position of the robot 2, the data processing device 5 determines in a step S10 (cf. FIG. 2) a current pose of this robot relative to an environment-based reference system, which is indicated in FIG. 1 as (x, y, z). Analogously, the data processing device 5 determines a current pose of the robot 30 from the joint position of the robot 30, in particular an odometrically detected pose of its mobile base.

Likewise, the data processing device 5 can also determine the current pose of the robot 1 and/or 30 on the basis of the sensor 1 in step S10, which can be particularly advantageous in the case of the mobile robot.

Then, in a step S20, the data processing device 5 determines from these detected poses each of the monitored spatial areas that are penetrated by the given robot(s)—that is, in which the given robot(s) is at least partially present. These monitored spatial areas are each indicated by cross-hatching in FIG. 1 (these are different for the two robots 1, 30).

On the basis of the sensor signals from the sensors 1, 31, the data processing device 5 also determines in step S20 a pose of unforeseen obstacles, and which of the monitored spatial areas are penetrated by the given obstacle—that is, in which the given obstacle is at least partially present.

For this purpose, a person 4 is shown by way of example in FIG. 1. In addition, the monitored spatial area F_{6.1} which this person has penetrated is indicated by cross-hatching.

Then, in a step S30, the data processing device 5 determines for each of the robots 2, 30 the minimum distances between all monitored spatial areas penetrated by an unforeseen obstacle (in the embodiment, the single monitored spatial area F_{6.1}) and the monitored spatial area penetrated by the robot—of which FIG. 1 shows by way of example the spatial areas F_{4.2}, F_{5.3} and F_{8.3}, with indices (the indices each identify the row and column of the corresponding monitored spatial area).

Then, in step S30, the data processing device 5 selects the least of these minimum distances for each of the robots 2, 30,—that is, the least minimum distance between a monitored spatial area penetrated by the robot and a monitored spatial area penetrated by the obstacle—as the minimum distance between each given robot and the obstacle.

For this purpose, the minimum distances _{6.1}a_{4.2} between the monitored spatial areas F_{6.1} and F_{4.2, 6.1}a_{5.3} between F_{6.1} and F_{5.3} and _{6.1}a_{8.3} between F_{6.1} and F_{8.3.} are indicated by way of example in FIG. 1. On the basis of the environment-based, prespecified monitored spatial areas, these distances can advantageously be determined in advance and saved in tabular form.

It can be seen that the minimum distance between the obstacle 4 and the robot 2 and/or the monitored spatial areas that are penetrated by them and that are closest to each other is the distance _{6.1}a_{5.3,} since none of the other spatial areas currently penetrated by the robot 2 has a lesser distance from the spatial area penetrated by the obstacle 4, and it can also be seen that the minimum distance between the obstacle 4 and the robot 30 or the monitored spatial areas that are penetrated by them and that are closest to each other is the distance _{6.1}a_{4.2}.

Then, in a step S40, the data processing device 5 determines an amount for each of the robots 2, 30 by which the maximum velocity permitted for this robot with a free working area is reduced, this amount increasing with the determined minimum distance, and transmits this amount to the robot(s) or its controller, which then reduces the maximum velocity accordingly in a step S50.

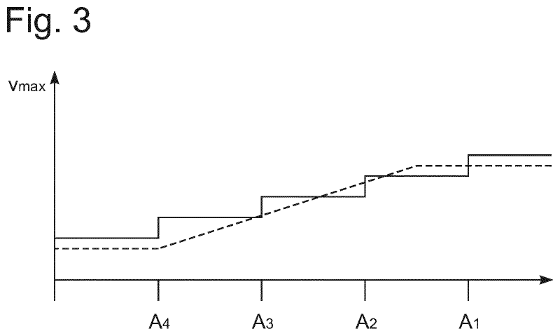

FIG. 3 shows an example of such a reduction of the maximum velocity of the robot 2 as a solid line. It can be seen that its maximum velocity is reduced if the minimum distance to the obstacle 4 falls below a first minimum distance A₁, is reduced even more if the minimum distance (also) falls below a second minimum distance A₂ which is less than the first minimum distance, is reduced even more if the minimum distance (also) falls below a third minimum distance A₃, which is less than the second minimum distance, and is reduced even more if the minimum distance falls below (even) a fourth minimum distance A₄ which is less than the third minimum distance.

Although embodiments have been explained in the preceding description, it is noted that a large number of modifications are possible.

In particular, instead of the monitored spatial areas penetrated by a robot, the minimum distance between the monitored spatial area (closest to the robot) and one or more robot-based references, in particular its elbow, end flange and/or tool, can be determined directly.

Instead of the step-by-step reduction explained with reference to FIG. 3, the maximum velocity can also be reduced, at least partially, continuously as the distance decreases.

As an example, FIG. 3 shows such a reduction in the maximum velocity for the robot 30 as a dashed line. In addition, FIG. 3 also shows that the maximum velocity can be reduced differently for different robots.

It is also noted that the embodiments are merely examples that are not intended to restrict the scope of protection, the applications and the structure in any way. Rather, the preceding description provides a person skilled in the art with guidelines for implementing at least one embodiment, with various changes, in particular with regard to the function and arrangement of the described components, being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### REFERENCE NUMERALS

1 camera (sensor)
2 stationary robot
30 mobile robot
31 laser scanner (sensor)
32 robot arm
33 gripper
34 payload
4 person (obstacle)
5 external data processing device
F_{4.2}, F_{5.3}, F_{6.1}, F_{8.3} monitored spatial area
_{6.1}a_{4.2, 6.1}a_{5.3, 6.1}a_{8.3} distance
(x, y, z) environment-based reference
A1, A2, A3, A4 minimum distance

What is claimed is:

1-10. (canceled)

11. A method for operating at least one robot, the robot including a manipulator arm comprising a plurality of joints and corresponding drives for actuating the joints controlled by a robot controller, the method comprising:
determining with a computer a minimum distance between the robot and an obstacle;
issuing a command by the robot controller to at least one drive of the robot for reducing a maximum velocity of the robot in response to the determined minimum distance falling below a first minimum distance value; and
issuing a command by the robot controller to at least one drive of the robot for further reducing the maximum velocity of the robot in response to the minimum distance falling below a second minimum distance value that is less than the first minimum distance value.

12. The method of claim 11, wherein the minimum distance is at least one of:
determined for an obstacle that is closest to the robot;
determined while excluding at least one previously known obstacle; or
determined while excluding at least one previously known temporary obstacle.

13. The method according to claim 11, further comprising:
at least one of:
determining a pose of the obstacle, or
determining a pose of the robot;
wherein the minimum distance is determined on the basis of at least one of the pose of the obstacle or the pose of the robot.

14. The method of claim 13, wherein at least one of:
determining a pose of the obstacle comprises determining the pose relative to a reference fixed in the environment; or
determining a pose of the robot comprises at least one of:
determining the pose relative to a reference fixed in the environment,
determining the pose relative to the same reference used for determining the pose of the obstacle,
determining the pose based on an end effector of the robot,
determining the pose based on a detected joint position of the robot, or
determining the pose based on a payload carried by the robot.

15. The method of claim 11, wherein the determining the minimum distance includes determined the minimum distance with at least one sensor.

16. The method of claim 15, wherein at least one of:
determining the minimum distance with the sensor comprises determining the minimum distance on the basis of at least one of the pose of the obstacle or the pose of the robot;
the at least one sensor is on of environment-based or robot-based;
determining the minimum distance with the sensor comprises determining the minimum distance by at least one of:
image processing, laser light, ultrasound, radar emission, a light grid, a projection, or in a capacitive manner.

17. The method of claim 11, wherein the minimum distance is determined by at least one data processing device which is external to the robot.

18. The method of claim 11, wherein determining the minimum distance comprises determining the minimum distance to a spatial area of a group that comprises a plurality of discrete spatial areas.

19. The method of claim 18, wherein at least one of:
determining the minimum distance to a spatial area comprises determining the minimum distance between a first discrete spatial area of the group, and a second discrete spatial area of the group or of a different group of discrete spatial areas; or
the discrete spatial areas are prespecified, environment-based spatial areas.

20. The method of claim 11, wherein reducing the maximum velocity comprises at least one of:
reducing the maximum velocity in steps between at least two minimum distances; or
reducing the maximum velocity continuously between at least two minimum distances.

21. The method of claim 11, wherein reducing the maximum velocity comprises at least one of:
reducing the maximum velocity on the basis of a relative velocity between the obstacle and the robot;
reducing the maximum velocity on the basis of a planned movement of the robot; or
reducing the maximum velocity as a function of at least one of:
a working reach, a current velocity, or a payload.

22. The method of claim 11, wherein at least one of:
reduction of the maximum velocity is parameterized by a user;
reduction of the maximum velocity is based on a configuration of a signal transmission of at least one of the robot or of a sensor for determining the minimum distance.

23. A system for operating at least one robot, the system comprising:
means for determining a minimum distance between the robot and an obstacle
means for reducing a maximum velocity of the robot in response to the determined minimum distance falling below a first minimum distance value; and
means for further reducing the maximum velocity of the robot in response to the minimum distance falling below a second minimum distance value that is less than the first minimum distance value.

24. The system of claim 23, wherein the minimum distance is at least one of:
determined for an obstacle that is closest to the robot;
determined while excluding at least one previously known obstacle; or
determined while excluding at least one previously known temporary obstacle.

25. A computer program product for operating at least one robot, the robot including manipulator arm and drives for moving the manipulator arm, the computer program product including program code stored on a non-transient, computer-readable storage medium, the program code, when executed by a computer, causing the computer to:
determine a minimum distance between the robot and an obstacle;
reduce a maximum velocity of the robot in response to the determined minimum distance falling below a first minimum distance value; and
further reduce the maximum velocity of the robot in response to the minimum distance falling below a second minimum distance value that is less than the first minimum distance value.
